(19) United States
(12) Patent Application Publication
(10) Pub. No.: US 2025/0302272 A1
(43) Pub. Date: Oct. 2, 2025

(54) DISH MACHINE WITH ENHANCED ENERGY EFFICIENCY

(71) Applicant: Ecolab USA Inc., Saint Paul, MN (US)

(72) Inventor: Jiaquan Fu, Shanghai (CN)

(21) Appl. No.: 18/863,730

(22) PCT Filed: May 11, 2023
(86) PCT No.: PCT/US2023/066890

§ 371 Date: Nov. 7, 2024

(30) Foreign Application Priority Data
May 11, 2022 (CN) 202210511700.1

(51) Int. Cl. A47L 15/42; A47L 15/00; A47L 15/48

(52) U.S. Cl. CPC A47L 15/4291; A47L 15/0078; A47L 15/0081; A47L 15/4209; A47L 15/4217; A47L 15/4219; A47L 15/4223; A47L 15/4225; A47L 15/4285; A47L 15/486; A47L 2501/02

(57) ABSTRACT

One or more devices for a dish washing machine are disclosed herein. For instance, the dish washing machine may include one or more energy recovery devices configured to transfer heat between components of the dish washing machine. In various embodiments, the present subject matter simplifies maintenance (e.g., cleaning, replacement of parts) and use (e.g., replenishment of detergents, or the like) of dish washing machines (e.g., a dishwasher, or the like).

### CROSS-REFERENCE TO RELATED APPLICATIONS

This application claims the benefit of priority of Chinese Application No. 202210511700.1, filed May 11, 2022, which is hereby incorporated by reference in its entirety.

### FIELD OF THE INVENTION

The present subject matter relates to the technical field of dish machines, and in particular, to a dish washing machine steam recovery device.

### BACKGROUND

A dishwasher is used to clean dishes, cookware, silverware, or the like. Heated water and detergent are used to clean the items and then is disposed down the drain. There is an ever-increasing need for more water efficient and energy efficient dish washing machines. There is also a need in the art for machines that are easier to build with fewer parts. There is also a need for machines that are easier to maintain and operate.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A illustrates a side view of an example of a dishwasher according to one embodiment of the present subject matter.

FIG. 1B illustrates a rear view of the dishwasher of FIG. 1A.

FIG. 1C illustrates a cross-sectional view of the dishwasher of FIG. 1A at line D-D.

FIG. 1D illustrates a detailed cross-sectional view of the dishwasher of FIG. 1C at the detail circle D.

FIG. 2A illustrates a side view of another example of the dishwasher according to one embodiment of the present subject matter.

FIG. 2B illustrates a rear view of the dishwasher of FIG. 2A.

FIG. 2C illustrates a cross-sectional view of the dishwasher of FIG. 2A at line C-C.

FIG. 2D illustrates a cross-sectional view of the dishwasher of FIG. 2B at line D-D.

FIG. 3A illustrates a front view of yet another example of the dishwasher according to one embodiment of the present subject matter.

FIG. 3B illustrates a cross-sectional view of the dishwasher of FIG. 3A at line B-B.

FIG. 3C illustrates a cross-sectional view of the dishwasher of FIG. 3A at line C-C.

FIG. 3D illustrates a cross-sectional view of the dishwasher of FIG. 3B at line D-D.

FIG. 4A illustrates a top perspective view of an example of a heat recovery system according to one embodiment of the present subject matter.

FIG. 4B illustrates a bottom perspective view of the heat recovery system of FIG. 4A.

FIG. 4C illustrates a side view of the heat recovery system of FIG. 4A.

FIG. 4D illustrates a top view of the heat recovery system of FIG. 4A.

FIG. 4E illustrates a cross-sectional view of the heat recovery system of FIG. 4D at line E-E.

FIG. 4F illustrates a detailed cross-sectional view of the heat recovery system of FIG. 4E at detail circle F.

FIG. 4G illustrates a cross-sectional view of the heat recovery system of FIG. 4D at line G-G.

FIG. 4H illustrates a detailed cross-sectional view of the heat recovery system of FIG. 4G at detail circle H.

FIG. 4I illustrates a cross-sectional view of the heat recovery system of FIG. 4D at line I-I.

### DETAILED DESCRIPTION

The present subject matter involves increasing the energy efficiency of dish washing machines. In various embodiments the present subject matter simplifies maintenance (e.g., cleaning, replacement of parts) and use (e.g., replenishment of detergents, or the like) of dish washing machines (e.g., a dishwasher, or the like).

In various examples, the dishwasher includes a high-temperature heating system that heats the water within the dishwasher. The dishwasher may include a waste water heat recovery device that captures heat from the waste water of the dishwasher. In yet another example, the dishwasher may include a steam recovery device that captures energy from steam generated by the dishwasher. Accordingly, the resulting machine provides enhanced energy efficiency by using one or more of the high-temperature heating system, waste water heat recovery device, or the steam recovery device. In various embodiments, the design of the dishwasher is simplified, for example because the waste water heat recovery device (or steam recovery device) does not employ a coil for transferring heat. Thus, cleaning of the dishwasher is also simplified because the dishwasher does not employ a coil.

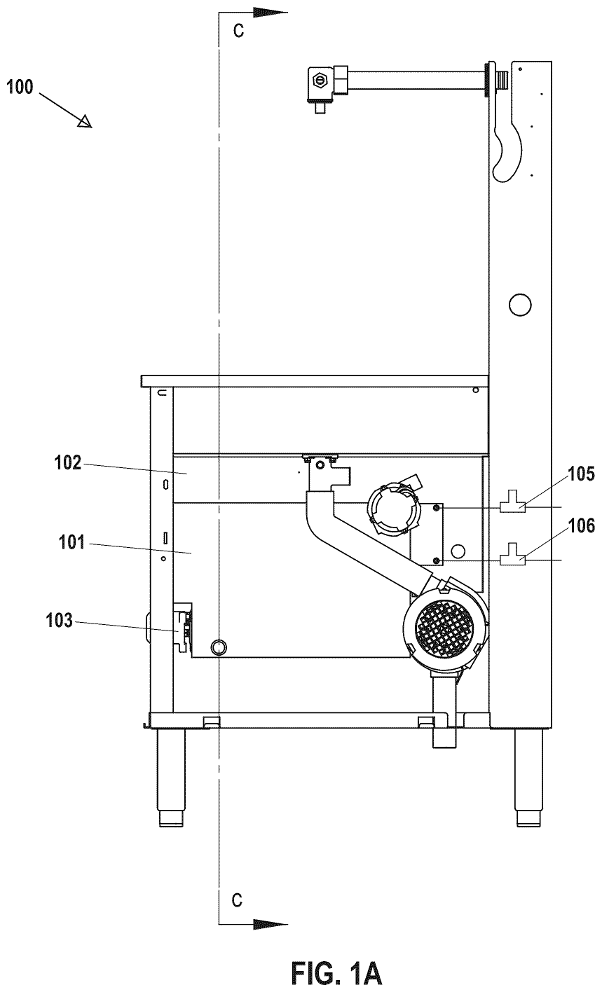

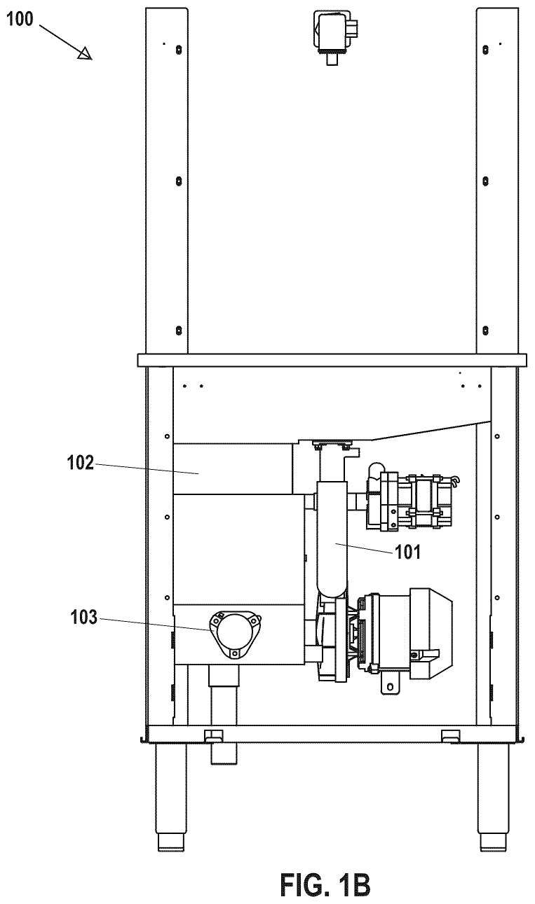

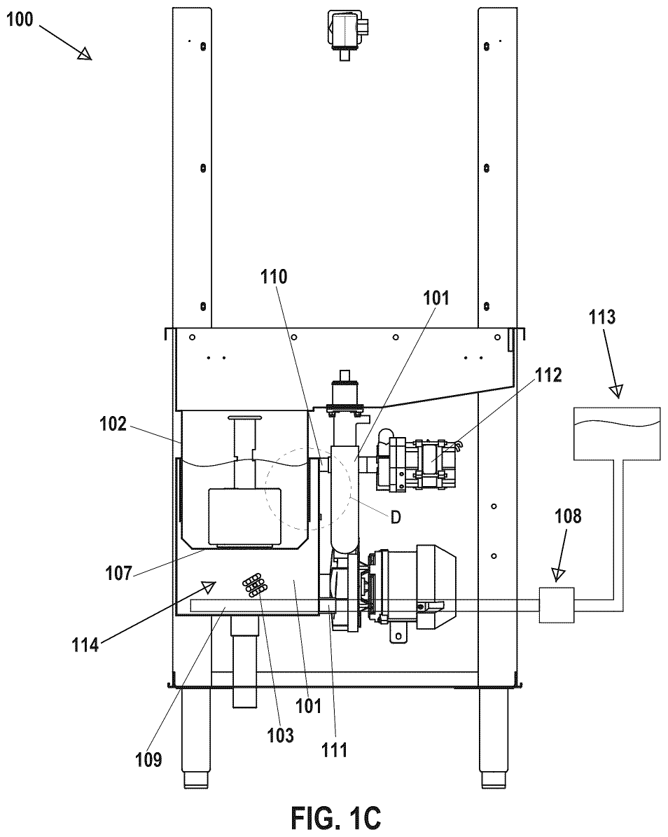

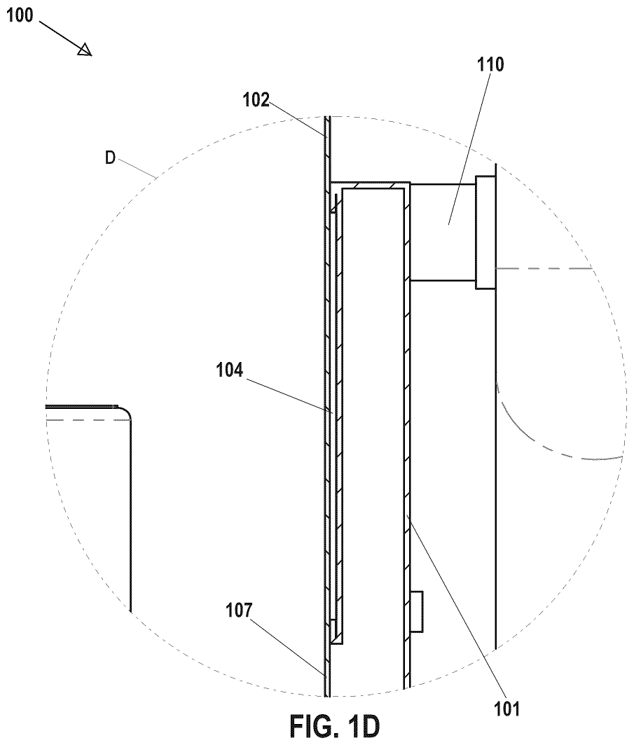

FIGS. 1A, 1B, 1C, and 1D illustrate side, rear, cross-sectional, and detailed cross-sectional views (respectively). In an example, the temperature of the high-temperature flushing water tank is specified to be above 82 degrees Celsius, and the temperature of the main washing water tank is specified to be 55 to 60 degrees Celsius. In some approaches, a dishwasher may include separate heaters for each of a washing water tank and a main washing water tank. The main washing water tank may include a low-level alarm to prevent its heater from burning out. The washing water tank may include a level controller to prevent the heater from burning out. The washing water tank may include a high-level control, for instance to prevent excessive water replenishment.

The dishwasher 100 may use a high-temperature flushing water tank to heat the main washing water tank. Accordingly, performance of the dishwasher is enhanced, for instance because the main washing water tank may heat without a heater directly heating the water within the main washing water tank. Thus, the dishwasher 100 may minimize burning of one or more heaters of the dishwasher 100.

The dishwasher 100 may adjust the temperature of the main wash tank by adjusting the heat transfer coefficient (or rate of heat transfer) with a thermal insulation chamber. The dishwasher 100 may include a flushing water pump in communication with an upper part of the high-temperature flushing water tank. The dishwasher 100 may include the water supply tank of the flushing water tank arranged such that the water level of the water supply tank is higher than that of the flushing water pump. The high-temperature flushing water tank can be automatically exhausted (e.g., drained, or the like) without the need for an exhaust pipeline. Accordingly, the high-temperature flush tank maintains its water level, for instance without an alarm or level control to operate the dishwasher 100.

In an example, a dishwasher 100 may include a heating system 114. For instance, the dishwasher may include one or more of a high-temperature flushing water tank 101, a main washing water tank 102, a high-temperature flushing water tank heater 103, a thermal insulation chamber 104, a water inlet control valve 105, a thermal insulation chamber water discharge control valve 106, a water tank partition plate 107. In some examples, the water tank partition plate 107 is separate from the thermal insulation chamber 104.

In another example, the dishwasher 100 may include the high temperature flushing water tank heater 103 located in the high temperature flushing water tank 101. The dishwasher 100 may include the flushing water tank 101 arranged together with the main washing water tank 102. The water tank partition plate 107 may separate water in the high-temperature flushing water tank 101 from water in the main washing water tank 102.

In yet another example, an upper end of the thermal insulation chamber 104 may communicate with the water inlet control valve 105. A lower end of the thermal insulation chamber 104 may communicate with the water release control valve 106 of the thermal insulation chamber 104. For instance, opening of (e.g., permitting flow through, or the like) the water inlet control valve 105 introduces water into the thermal insulation chamber 104. Accordingly, the heat transfer coefficient (or rate of heat transfer) of the insulation chamber 104 increases in correspondence with introduction of water into the thermal insulation chamber 104. Closing of the water inlet control valve 105 may cease introduction of water into the thermal insulation chamber 104.

Opening of the water release control valve 106 may discharge water from the thermal insulation chamber 104. Accordingly, discharging of water may reduce the water level in the insulation chamber 104. Discharging of water from the thermal insulation chamber 104 may decrease the heat transfer coefficient (or rate of heat transfer) of the insulation chamber 104. For instance, the heat transfer coefficient (or rate of heat transfer) of the thermal insulation chamber 104 may decrease in correspondence with discharging water from the thermal insulation chamber 104.

In still yet another example, water in the high-temperature flushing water tank 101 is heated by the high-temperature flushing water tank heater 103. The high-temperature flushing water tank 101 may transfer heat to the main washing water tank 102. For example, the high-temperature flushing water tank 101 may transfer heat to the main washing water tank 102 in correspondence with heating of the high-temperature flushing water tank 101 by the high-temperature flushing water tank heater 103. Accordingly, the dishwasher 100 may heat water in the main washing water tank 102 using the high-temperature flushing water tank 101. For instance, the water tank partition plate 107 may facilitate transfer of heat between the high-temperature flushing water tank 101 and the main washing water tank 102. The thermal insulation chamber 104 may facilitate transfer of heat between the high-temperature flushing water tank 101 and the main washing water tank 102. Thus, performance of the dishwasher is enhanced, for example because the energy efficiency of the dishwasher 100 is enhanced by the transfer of heat between the high-temperature flushing water tank 101 and the main washing water tank 102.

Referring to FIGS. 1A through 1D, the dishwasher 100 may include one or more of a high-temperature flushing water tank inlet control valve 108, a high-temperature flushing water tank inlet extension 109, a high temperature flushing water tank outlet 110, a high-temperature flushing water tank inlet 111, a flushing water pump 112, or a flushing water tank water supply tank 113. In an example, the dishwasher 100 may include the high temperature flushing water tank outlet 110 arranged above the high temperature flushing water tank 101. The dishwasher 100 may include the high temperature flushing water tank outlet 110 arranged above the inlet of the flushing water pump 112.

An outlet of the high-temperature flushing water tank inlet control valve 108 may communicate with the high-temperature flushing water tank inlet 111. An inlet of the high-temperature flushing water tank inlet control valve 108 may communicate with the flushing water tank water supply tank 113. The dishwasher 100 may open the high-temperature flushing water tank inlet control valve 108 in correspondence with operation of the flushing water pump 112. The dishwasher 100 may use the flushing water pump 112 to pump water into the high-temperature flushing water tank 101.

In a further example, low-temperature makeup water in the flushing water tank water supply tank 113 may flow into the high-temperature flushing water tank 101, for instance through the high-temperature flushing water tank inlet 111 using the high-temperature flushing water tank inlet extension 109. The extended inlet pipe 109 may minimize cold make-up water from directly entering the flushing pump. The dishwasher 100 may include the flushing water tank water supply tank 113 arranged such that the water level of the water supply tank 113 is higher than the flushing water pump 112.

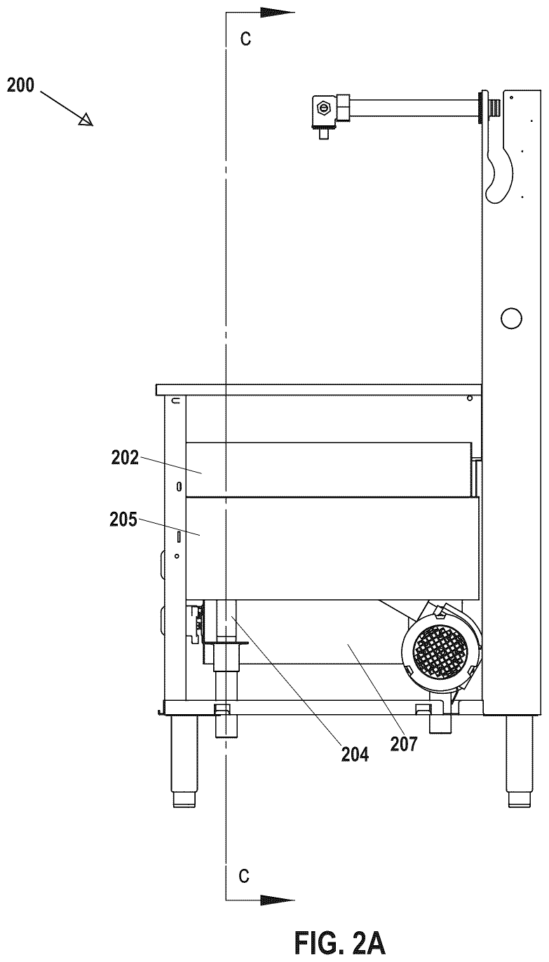

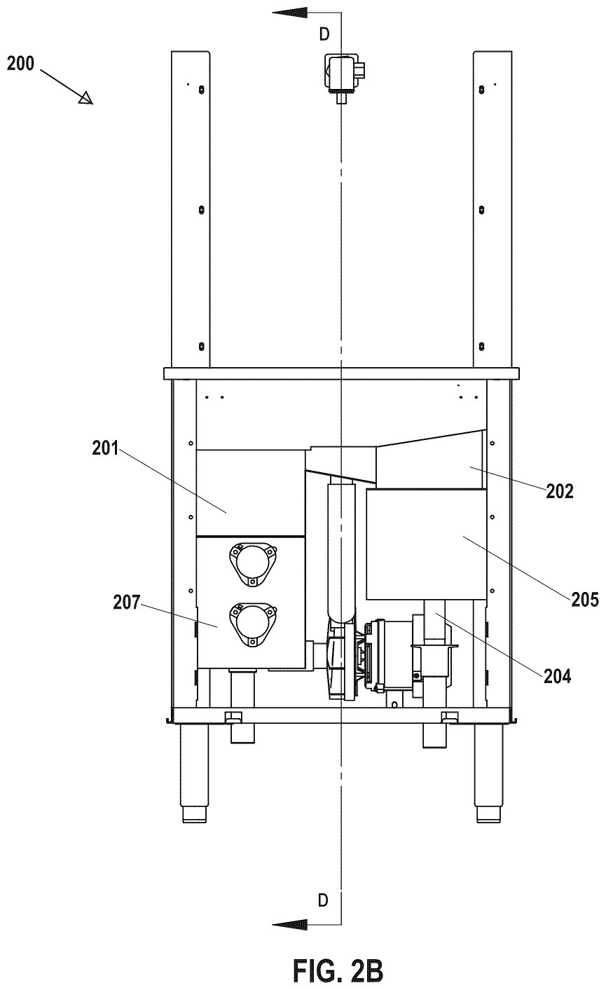

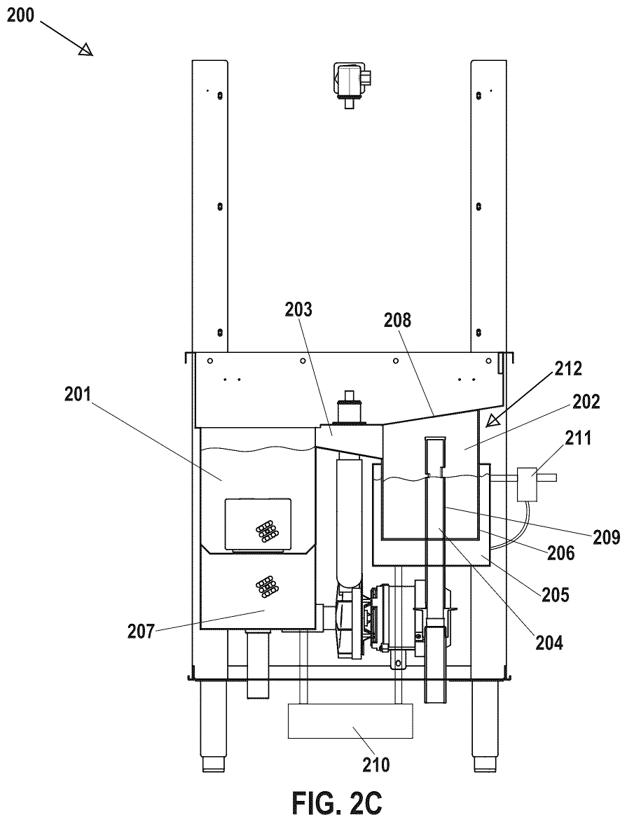

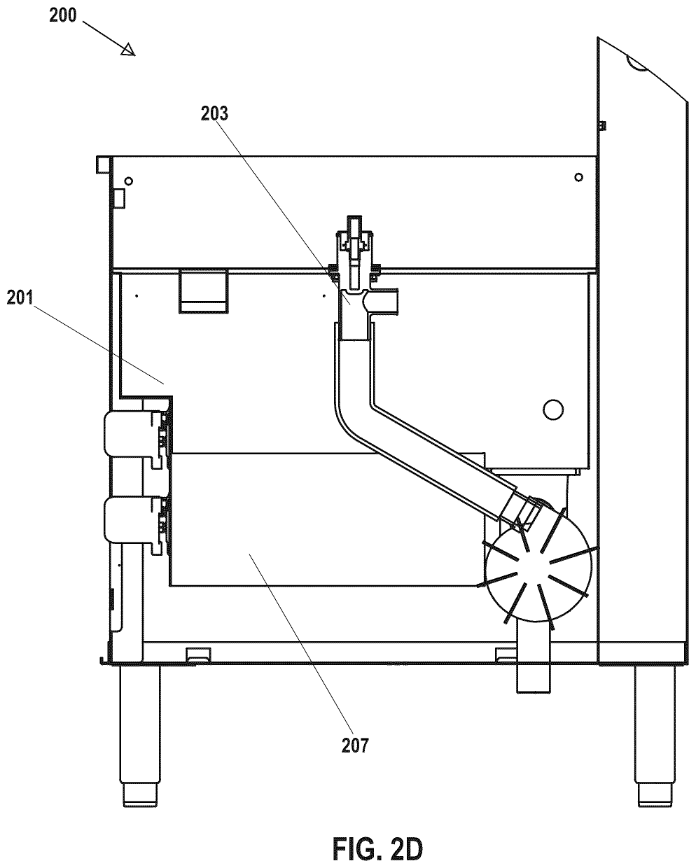

FIGS. 2A, 2B, 2C, and 2D illustrate side, rear, and cross-sectional views (respectively) of another example of the dishwasher according to one embodiment of the present subject matter.

Heat recovery in a dishwasher may enhance energy efficiency of the dishwasher. For instance, the temperature of the overflowing water from the main washing water tank may range from 55 to 60 degrees Celsius (however the present subject matter is not so limited). Thus, recovering the heat from the waste water may enhance the energy efficiency of a dishwasher.

In some approaches, a waste water heat recovery device includes a coil that facilitates heat exchange. The dishwasher may include the coil located in a waste water tank. The coil may heat water (e.g., wash water, rinse water, or the like) using energy provided by the waste water in the waste water tank as the water (to be heated) flows through the coil.

In some approaches, the coil is immersed in the waste water tank for an extended period of time. Thus, surfaces of the coil may accumulate dirt or produce unpleasant odors. Further, a user may determine cleaning the coil is inconvenient. Still further, the material of the coil may include copper, which is expensive.

The present subject matter may provide a solution to these problems, for example by interchanging the coil for one or more heat exchange plates. The plates may provide simplified cleaning of the dishwasher. Accordingly, the present subject matter may enhance user satisfaction with the dishwasher. Further, the heat exchange plates may not employ copper. Thus, present subject matter may reduce costs associated with manufacturing the dishwasher. In another example, the rinsing water pump is located in front of the rinsing water tank, for instance to reduce the working temperature of the rinsing water pump. In yet another example, the dishwasher having the rinsing water pump located in front of the rinsing water tank helps maintain the water level in the recovery water tank at a level higher than the water level in the rinsing water tank. Thus, the dishwasher may not employ a water level sensor to monitor the supply of water from the rinsing water tank. Accordingly, the present subject matter enhances reliability of a dishwasher.

Referring to FIGS. 2A-2D, a dishwasher 200 may include a waste water heat recovery device 212, (e.g., for use in a commercial dishwasher, or the like). In some examples, the waste water heat recovery device 212 includes one or more of a main washing water tank 201, a waste water tank 202, a main washing water tank overflow channel 203, a waste water tank overflow channel 204, a recovery water tank 205, a water tank partition plate 206, a rinsing water tank 207, or a waste water tank cover 208. In an example, water in the main washing water tank 201 may overflow into the waste water tank 202. For instance, the main washing water tank 201 may communicate with the waste water tank 202 using the main washing water tank overflow channel 203. For example, water in the main washing water tank 201 may overflow into the main washing water tank overflow channel 203 based on a water level in the main washing water tank 201 being higher than a set washing overflow position.

In another example, water in the waste water tank 202 may overflow into a drain. Accordingly, the water in the waste water tank 202 may flow outside of the dishwasher through the waste water tank overflow channel 204 in correspondence with a water level in the waste water tank 202 being higher than a set waste overflow position.

In yet another example, the recovery water tank 205 at least partially surrounds the waste water tank 202. For example, the recovery water tank 205 may wrap around an exterior of the waste water tank 202. The water tank partition plate 206 may separate water in the recovery water tank 205 from the water in the waste water tank 202. The water tank partition plate 206 may facilitate transfer of heat between the recovery water tank 205 and the waste water tank 202. Water heated in the recovery water tank 205 (by the transfer of heat from waste water tank 202 may flow into the rinsing water tank 207.

The dishwasher 200 may include the waste water tank cover 208. The waste water tank cover 208 may inhibit communication between the waste water tank cover 208 and other portions of the dishwasher 200. A user may remove the waste water tank cover 208, for example to clean the dishwasher 200.

The dishwasher 200 may include a waste water tank overflow rod 209. The waste water tank overflow rod 209 may comprise the waste water tank overflow channel 204. A user may remove the waste water tank overflow rod 209. for example, to drain water from the waste water tank 202.

The dishwasher 200 may include one or more of a rinsing water pump 210 or a recovery water tank water level automatic control valve 211. The recovery water tank water level automatic control valve 211 may facilitate control of a water level of the recovery water tank 205. For instance, the dishwasher 200 may use the recovery water tank water level automatic control valve 211 to maintain the water level in the recovery water tank 205 at a level higher than the water level in the rinsing water tank 207. The dishwasher 200 may include the rinsing water pump 210 arranged between the rinsing water tank 207 and the recovery water tank 205. Thus, the rinsing water pump 210 may communicate with one or more of the recovery water tank 205 or the rinsing water tank 207.

In another example, the dishwasher 200 may include a waste water heat recovery device 212. The dishwasher 200 may use the waste water heat recovery device 212 to drain water from the dishwasher 200. For instance, the dishwasher 200 may drain water using the waste water heat recovery device 212 based on the water level in the recovery water tank 205 exceeding an overflow position. Accordingly, the water in the recovery water tank 205 may flow outside the dishwasher 200. In yet another example, the dishwasher 200 may include the main washing water tank overflow channel 203 located in an upper portion of the main washing water tank 201.

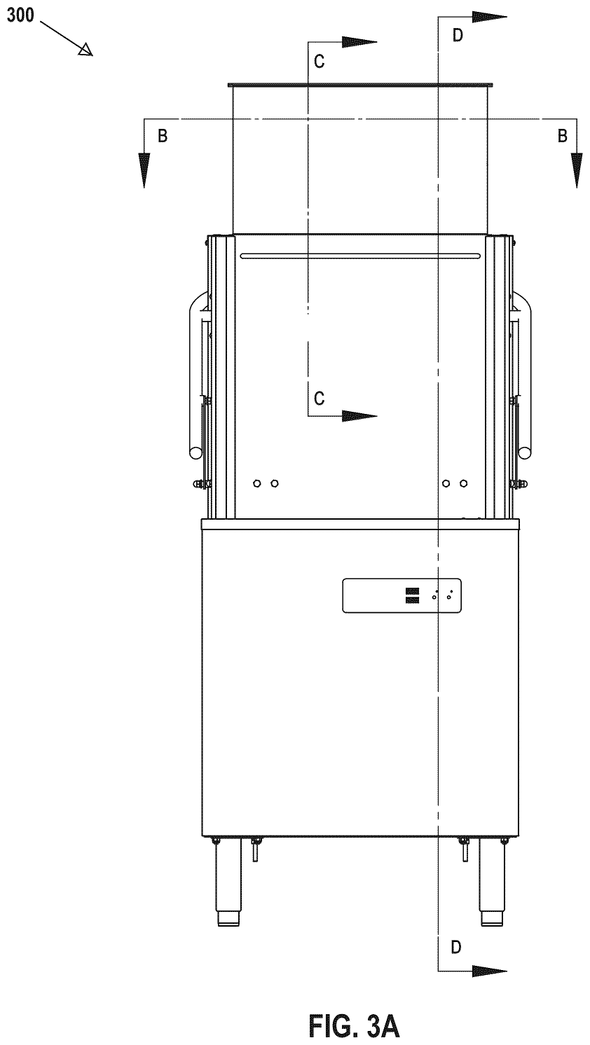

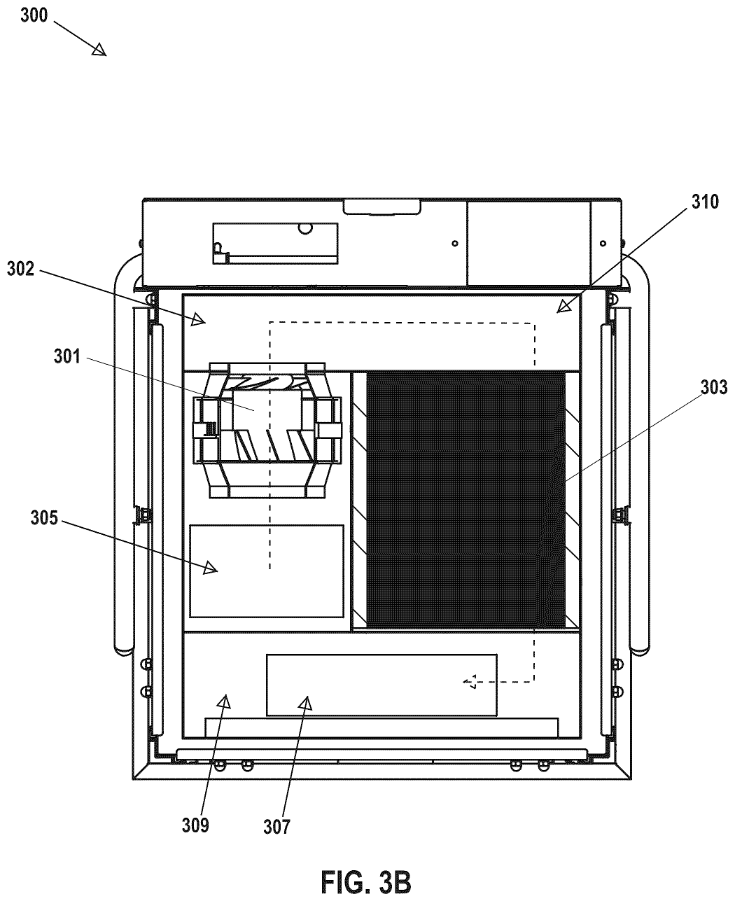

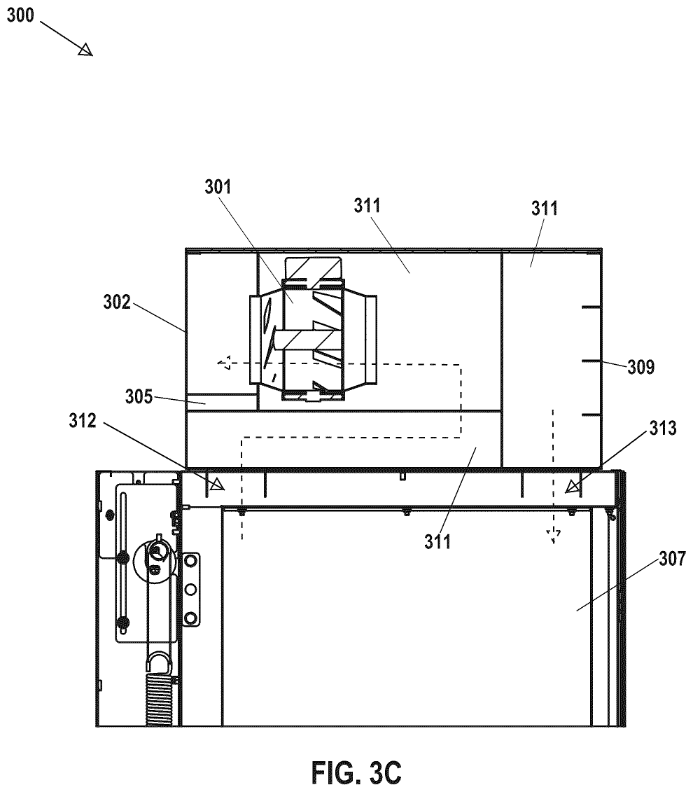

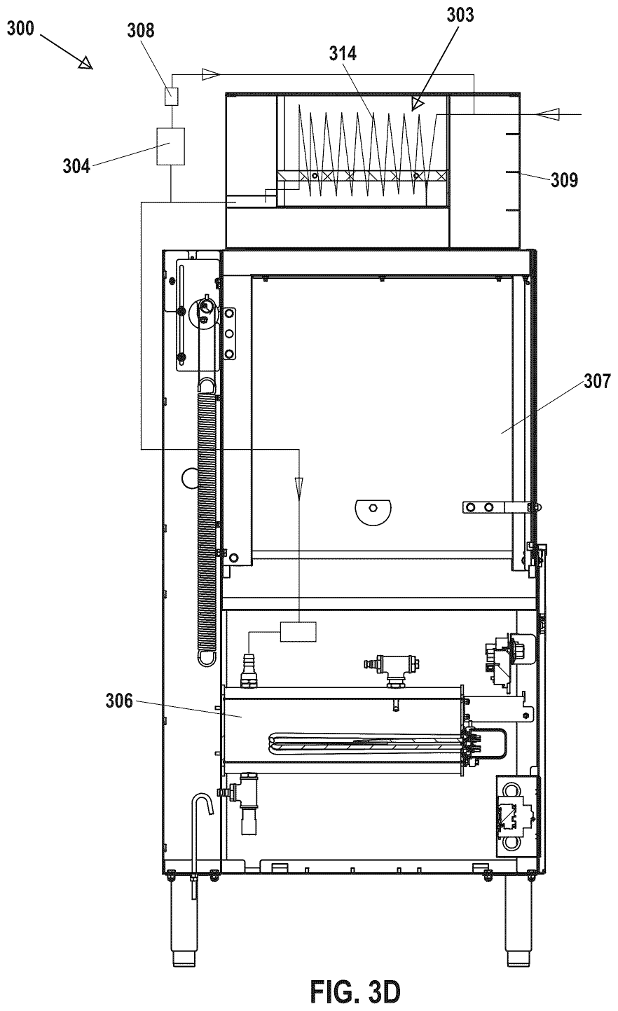

FIGS. 3A, 3B, 3C, and 3D illustrate front, and cross-sectional views (respectively) of yet another example of the dishwasher according to one embodiment of the present subject matter.

In one example of the present subject matter, a dishwasher includes a heat recovery device. The gasses (e.g., steam, or the like) generated by the dishwasher may flow through a heat exchanger, for example to transfer heat from the steam flowing through the heat exchanger. In another example, the waste water heat recovery device may employ a surface cooler for heat exchange. The heat exchanger may transfer heat to the wash water. For instance, the volume of the heat exchanger may be less than the volume of the wash water. Accordingly, the heat exchange rate provided by the heat exchanger may would be reduced. The volume of the heat exchanger may be greater than the wash water volume. Thus, the increase in volume of the heat exchanger may correspondingly increase the costs associated with manufacturing the heat exchanger. In yet another approach, the heat exchange tube may inhibit flow of water through the heat exchange. Accordingly, inhibited flow may reduce the rate of heat transfer provided by the heat exchanger.

The present subject matter provides a steam recovery device. In an example, a dish washing machine may include the steam recovery device. For instance, the steam recovery device may separate water from steam (e.g., using condensation, or the like). In another example, the steam recovery device disclosed herein may recover, or cycle, steam multiple times. Thus, the efficiency of the steam recovery device is enhanced. In yet another example, one or more of a circulating pump or an auxiliary water tank may increase the efficiency of the steam recovery device. The steam recovery device may include a one-way valve, for instance to maintain operation of the steam recovery device in correspondence with stoppage of the circulating pump.

In an example, a dishwasher 300 may include a steam recovery device 310. For example, the dishwasher may include one or more of a fan 301, a chamber 302, a heat exchanger 303 (e.g., surface cooling heat exchanger, or the like), a rinsing water tank 306, or a dishwasher washing chamber 307. The chamber 302 may include the fan 301 and the heat exchanger 303. The fan 301 may drive steam through the steam recovery device 310. The heat exchanger 303 may transfer heat from steam in the steam recovery device 310. The fan 301 may enhance a rate of heat transfer of the heat exchanger 303. The heat exchanger 303 may transfer heat to water flowing into the rinsing water tank 306.

The steam recovery device 310 may include ductwork 311. For instance, the ductwork 311 of the chamber 302 may direct flow of steam through the steam recovery device 310. The ductwork 311 may communicate with the dishwasher washing chamber 307. For instance, an inlet 312 of the ductwork 311 may communicate with the dishwasher washing chamber 307. For example, the inlet 312 may receive steam from a first portion of the dishwasher washing chamber 307 (e.g., a rear portion of the dishwasher washing chamber 307, or the like). An outlet 313 of the ductwork 311 may discharge fluid from the steam recovery device 310. For instance, the outlet 313 may communicate with the dishwasher washing chamber 307. In an example, the steam recovery device 310 may discharge fluid into the dishwasher washing chamber 307 using the outlet 313. The outlet 313 may discharge fluid into a second portion of the dishwasher washing chamber 307 (e.g., a front portion of the dishwasher washing chamber 307). FIGS. 3B and 3C include dashed lines (each ending with arrows) indicating direction of flow within the dishwasher 300 including the steam recovery device 310.

Referring to FIGS. 3A-3D, the steam recovery device 310 may include one or more of a circulating pump 304 or a steam recovery device auxiliary water tank 305. The heat exchanger 303 may communicate with steam recovery device auxiliary water tank 305. For example, an inlet of a heat exchange tube 314 of the heat exchanger 303 may be connected in series with one or more of the steam recovery device auxiliary water tank 305 or the circulating pump 304. The outlet of the heat exchange tube 314 of the heat exchanger 303 may communicate with one or more of the circulating pump 304 or the steam recovery device auxiliary water tank 305. Operation of the circulating pump 304 may circulate water through the steam recovery device auxiliary water tank 305 and the heat exchange tube 314 of heat exchanger 303. The dishwasher 300 may include a one-way valve 308. The one-way valve 308 may communicate with the circulating pump 304. For instance, the one-way valve 308 may be located behind the circulating pump 304, and the one-way valve 308 is arranged behind the circulating pump 304. For instance, the one-way valve may inhibit flow from the heat exchange tube 314 to the circulating pump 304.

The steam recovery device 310 may include a steam-water separator 309. Fluid in the dishwasher washing chamber 307 may flow through the heat exchanger 303. Fluid in the heat exchanger 303 may flow through the steam-water separator 309. Fluid in the steam-water separator 309 may flow to the dishwasher washing chamber 307.

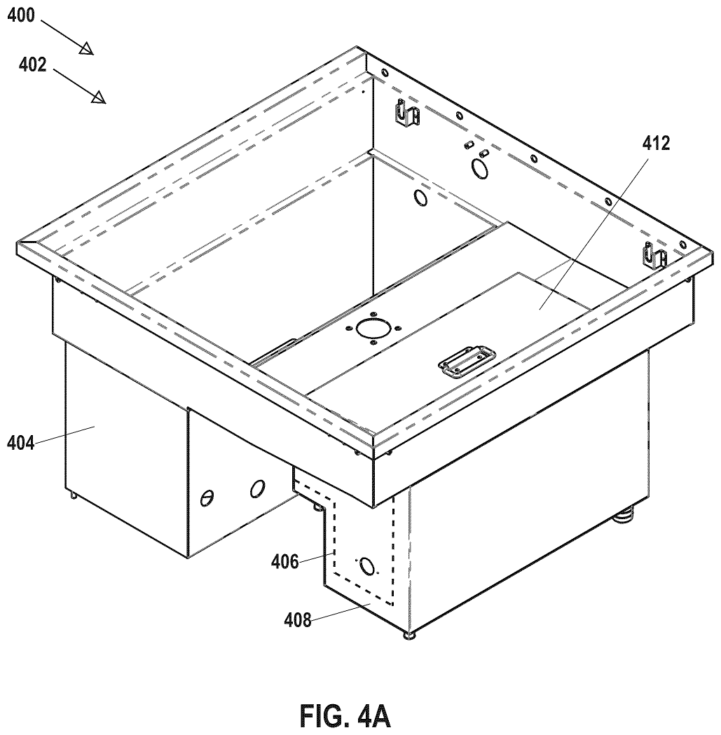

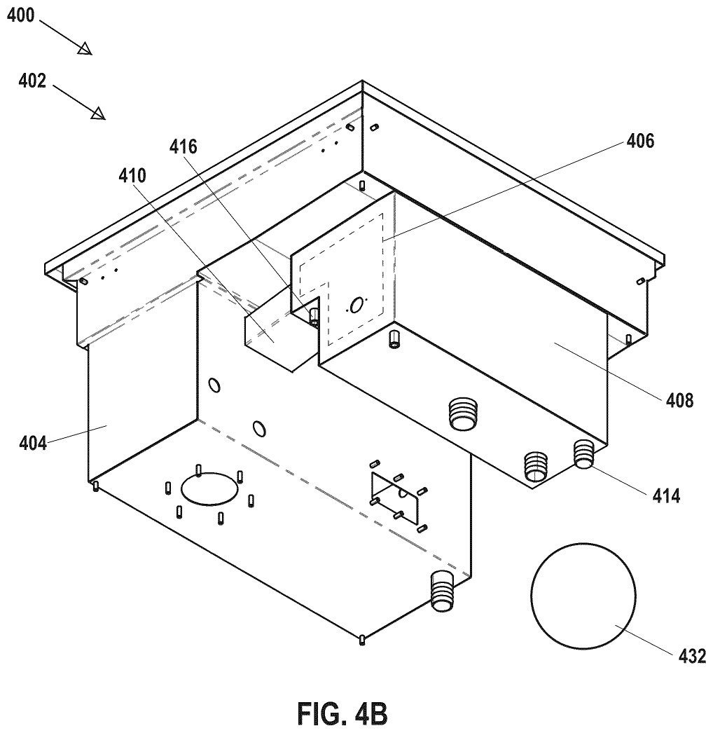

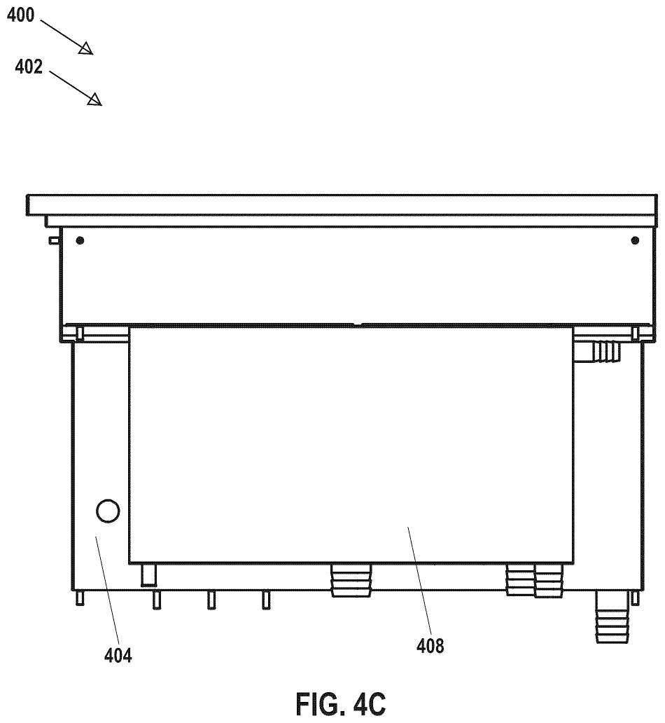

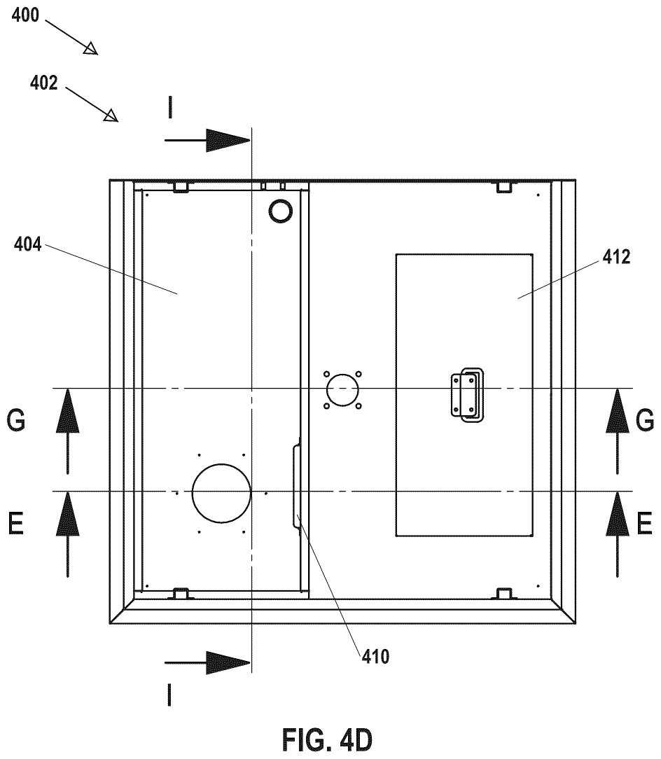

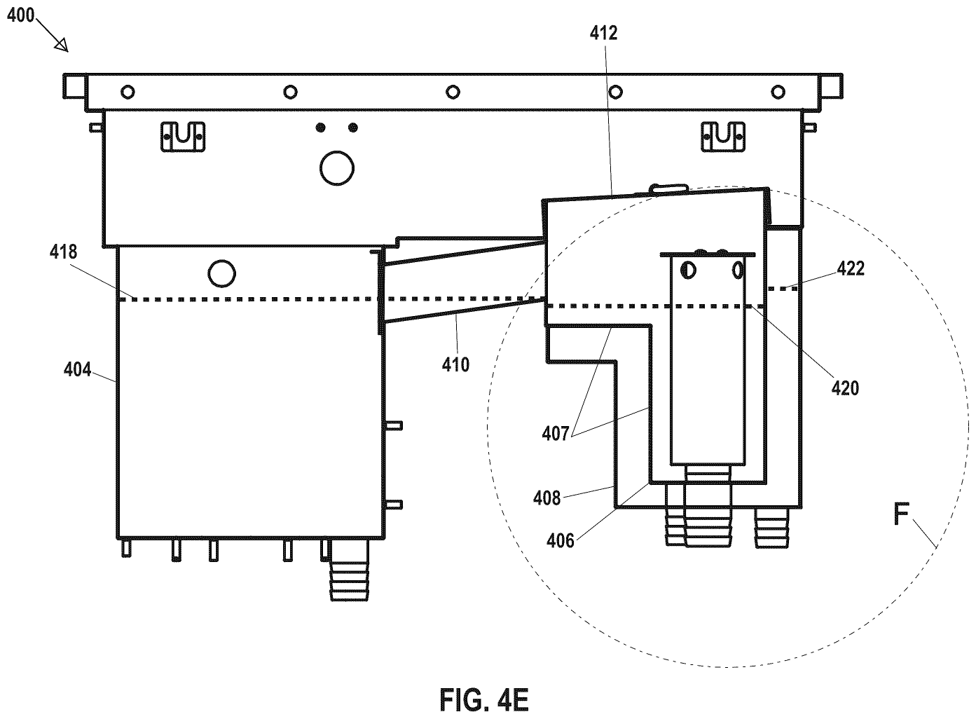

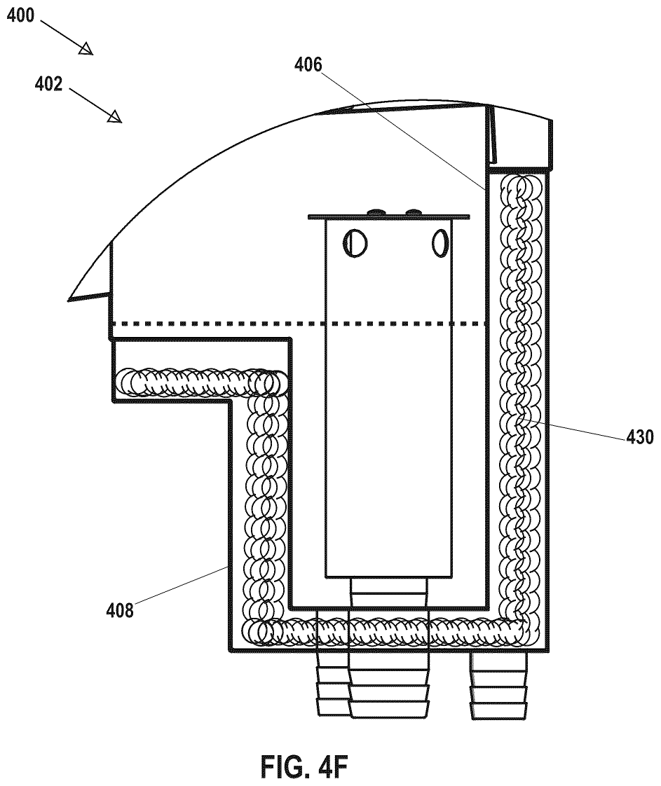

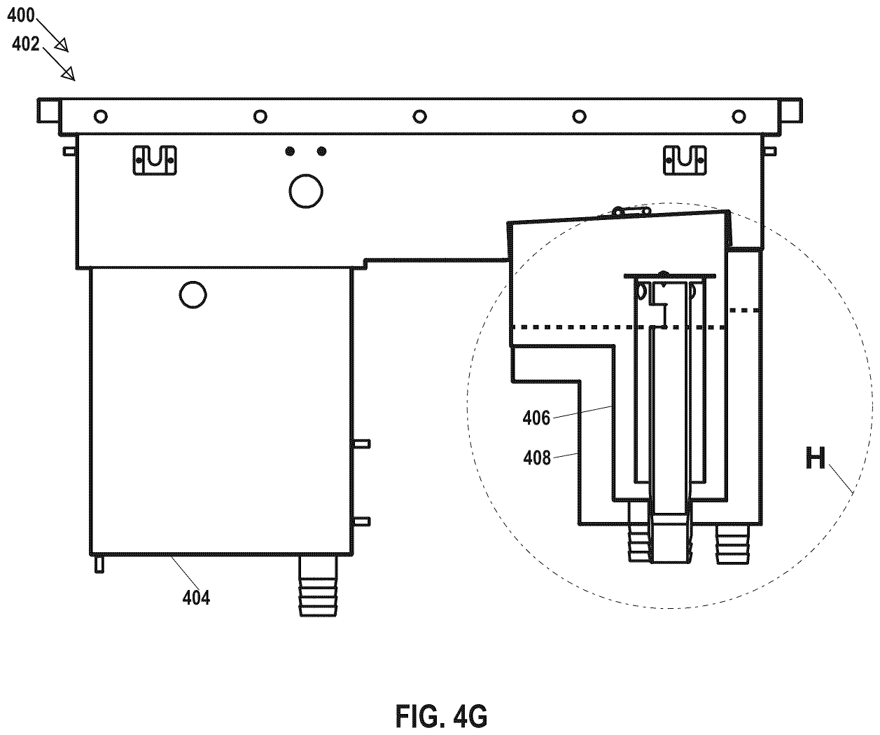

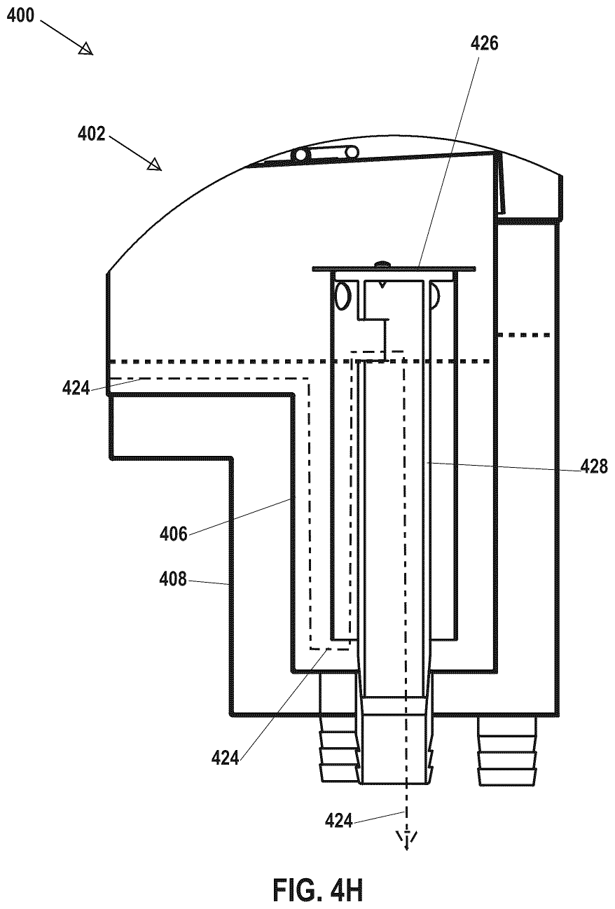

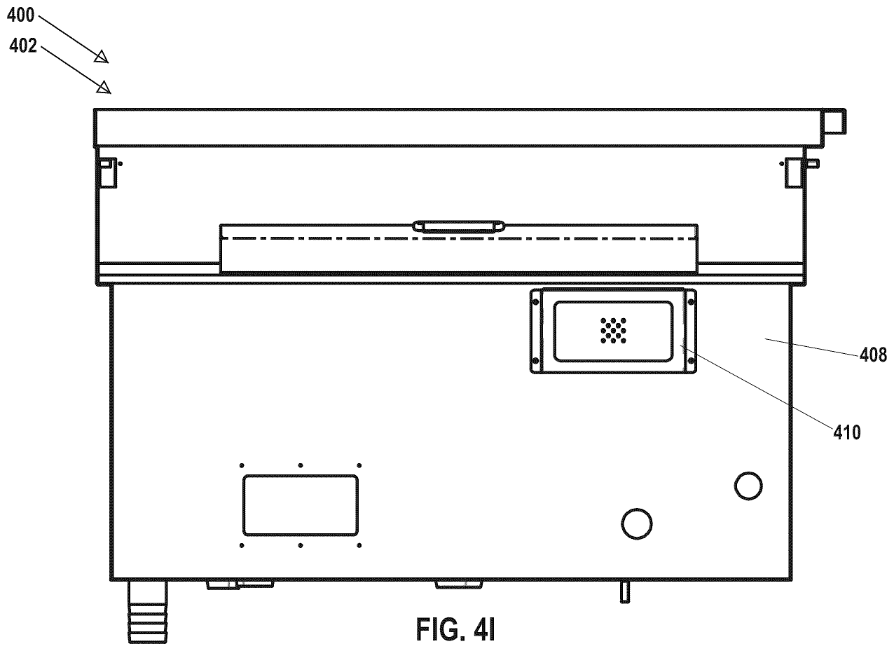

FIGS. 4A, 4B, 4C, 4D, 4E, 4F, 4G, 4H, 4I illustrate various views of an example of a heat recovery system 400, according to one embodiment of the present subject matter. One or more of the dishwasher 100, dishwasher 200, or the dishwasher 300 may employ the heat recovery system 400. The heat recovery system 400 may include a chamber 402. The heat recovery system may include one or more of a main wash tank 404, a waste water tank 406, a rinse water tank 408, an overflow channel 410, waste water tank cover 412, a first circulation port 414, or a second circulation port 416. In an example, the chamber 402 is sized and shaped to allow a user to access one or more components of the chamber 402, for instance one or more of the main wash tank 404, waste water tank 406, or the rinse water tank 408.

The main wash tank 404 may communicate with the waste water tank 406. In an example, water in the main wash tank 404 may flow to the waste water tank 406 using the overflow channel 410.

The heat recovery system 400 may include the waste water tank 406 at least partially surrounded by the rinse water tank 408. Accordingly, a heat transfer wall 407 may separate water in the waste water tank 406 from water in the rinse water tank 408. The heat transfer wall 407 may facilitate heat transfer between the waste water tank 406 and the rinse water tank 408. In an example, water heated in the main wash tank 404 may flow from the main wash tank 404 to the waste water tank 406 using the overflow channel 410. The waste water tank 406 may transfer heat from the water contained therein to the rinse water tank 408 using the heat transfer wall 407. Accordingly, the main wash tank 404 may supply heated water to the waste water tank 406 and correspondingly heat water in the rinse water tank 408.

FIGS. 4E, 4F, 4G, and 4H show dashed lines indicating levels of water in portions of the heat recovery system 400. In an example, water may flow from the main wash tank 404 to the waste water tank 406 using the overflow channel 410 in correspondence with a water level in the main wash tank 404 exceeding (e.g., greater than, or the like) a main wash tank level 418. Accordingly, the main wash tank 404 may supply heated water to the waste water tank 406. For instance, the waste water tank 406 may include a waste water tank level 420. The waste water tank level 420 may be less than main wash tank level 418 to facilitate flow from the main wash tank 404 to the waste water tank 406. Accordingly, heat recovery system 400 may transfer heat to water in the rinse water tank 408. In yet another example, a rinse water tank level 422 is greater than the waste water tank level 420. Thus, the heat recovery system 400 may enhance heat transfer between the waste water tank 406 and the rinse water tank 408.

Referring to FIGS. 4A-4I, the waste water tank 406 may include an upper portion corresponding to a lateral portion of the heat transfer wall 407. The waste water tank 406 may have a lower portion corresponding to a vertical portion of the heat transfer wall 407. The heat transfer wall 407 enhances heat transfer, for example by increasing surface area available for heat transfer in the upper portion of the rinsing water tank 306 where water temperatures are greater than the lower portion of the rinsing water tank 306.

In another example, water may flow from the rinsing water tank 306 through a circuitous route 424 (shown in FIG. 4H). In yet another example, circuitous route 424 may be sized and shaped to minimize its volume. Accordingly, heat transfer to the rinse water tank 408 may be enhanced. In still yet another example, the waste water tank 406 may include a drain cover 426 to provide access to a drain 428 of the chamber 402.

The heat recovery system 400 may circulate water in the rinse water tank 408. Circulating water may enhance heat transfer to the water in the rinse water tank 408. In an example, a pump 432 may drive fluid from a first circulation port 414 to a second circulation port 416. The first circulation port 414 may be located proximate a bottom of the rinse water tank 408. The second circulation port 416 may be located proximate a top of the rinse water tank 408. Accordingly, the heat recovery system 400 may circulate cooler water in the rinse water tank 408 to enhance heat transfer to the water (e.g., using convective heat transfer in addition to conduction through the heat transfer wall 407).

The heat recovery system 400 may include a packing material 430 configured to turbulate water in the rinse water tank 408. For instance, the packing material 430 may comprise a stainless steel net packing configured to disrupt flow within the rinse water tank 408. Thus, convection in the rinse water tank 408 is enhanced by turbulence provided by the packing material 430.

### EXAMPLES

This detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the inventors also contemplate examples in which only those elements shown or described are provided.

In this document, the terms “a” or “an” are used, as is common in patent documents, to include one or more than one, independent of any other instances or usages of “at least one” or “one or more.” In the following claims, the terms “first,” “second,” and “third,” etc. are used merely as labels, and are not intended to impose numerical requirements on their objects.

The above description is intended to be illustrative, and not restrictive. For example, the above-described examples (or one or more Examples thereof) may be used in combination with each other. Other embodiments may be used, such as by one of ordinary skill in the art upon reviewing the above description.

Example 1 is a high-temperature dishwasher heating system, comprising: a high-temperature flushing water tank; a main washing water tank; a high-temperature flushing water tank heater received in the high temperature flushing water tank and configured to heat the high-temperature flushing water tank; a thermal insulation chamber configured to transfer heat to the main washing water tank; and a water tank partition plate separating water in the high-temperature flushing water tank from water in the main washing water tank, the water tank partition plate configured to transfer heat between the high-temperature flushing water tank and the main washing water tank.

In Example 2, the subject matter of Example 1 optionally includes a water inlet control valve in communication with an upper portion of the thermal insulation chamber a thermal insulation chamber water discharge control valve in communication with a lower portion of the thermal insulation chamber; wherein the water inlet control valve is configured to introduce water into the thermal insulation chamber and correspondingly increase a heat transfer coefficient of the insulation chamber; and wherein the discharge control valve is configured to discharge water from the thermal insulation chamber and correspondingly reduce the heat transfer coefficient of the insulation chamber.

In Example 3, the subject matter of any one or more of Examples 1-2 optionally include a high-temperature flushing water tank inlet control valve; a high-temperature flushing water tank inlet; a high temperature flushing water tank outlet; a flushing water pump 3 is missing parent: 112 configured to pump high-temperature water for the high-temperature flushing water tank; a flushing water tank water supply tank having a water level higher than the flushing water pump; wherein the high temperature flushing water tank outlet is arranged above at least one of the high temperature flushing water tank, the high temperature flushing water tank outlet, or the inlet of the flushing water pump; wherein an inlet of the high-temperature flushing water tank inlet control valve is in communication with the flushing water tank water supply tank; and wherein an outlet of the high-temperature flushing water tank inlet control valve is in communication with the high-temperature flushing water tank inlet.

In Example 4, the subject matter of Example 3 optionally includes a high-temperature flushing water tank inlet extension configured to supply low-temperature makeup water from the flushing water tank water supply tank to the high-temperature flushing water tank through the high-temperature flushing water tank inlet.

Example 5 is a waste water heat recovery device for a dishwasher, the waste water heat recovery device comprising: a main washing water tank; a waste water tank; a main washing water tank overflow channel, wherein water in the main washing water tank can overflow into the waste water tank through the main washing water tank overflow channel in correspondence with a water level in the main washing water tank being higher than a set washing overflow position; a waste water tank overflow channel, wherein water in the waste water tank can overflow to outside of the dishwasher through the waste water tank overflow channel in correspondence with a water level in the waste water tank being higher than a set waste overflow position; a recovery water tank at least partially surrounding the waste water tank; a water tank partition plate separating water in the recovery water tank from water in the waste water tank, the water tank partition plate configured to transfer heat between the recovery water tank and the waste water tank; and a rinsing water tank configured to receive water from the recovery water tank.

In Example 6, the subject matter of Example 5 optionally includes a removable waste water tank overflow rod comprising the waste water tank overflow channel, wherein removal of the waste water tank overflow rod is configured to drain water from the waste water tank.

In Example 7, the subject matter of any one or more of Examples 5-6 optionally include a rinsing water pump between the rinsing water tank and the recovery water tank; a recovery water tank water level automatic control valve; and wherein the recovery water tank water level automatic control valve is configured to control a liquid level of the recovery water tank to be higher than the level in rinsing water tank.

In Example 8, the subject matter of Example 7 optionally includes a recovery water tank overflow line configured to receive water overflowing from the recovery water tank in correspondence with the level in the recovery water tank exceeding an overflow position.

In Example 9, the subject matter of any one or more of Examples 7-8 optionally include wherein: an upper portion of the main washing water tank comprises the main washing water tank overflow channel; and the recovery device includes a waste water tank cover configured for selective removal by a user; and wherein removal of the waste water tank cover provides access to the main washing water tank overflow channel.

In Example 10, the subject matter of any one or more of Examples 5-9 optionally include a waste water tank cover configured for selective removal and to inhibit flow of water into the waste water tank.

Example 11 is a dishwasher steam recovery device, comprising: a fan; a heat exchanger; a chamber having a fan and a heat exchanger; a rinsing water tank; a dishwasher washing chamber; a duct in communication with one or more of the dishwasher washing chamber, the fan, or the heat exchanger; wherein the fan is configured to drive fluid in the duct from the dishwasher washing chamber to the heat exchanger; and wherein an inlet and an outlet of a heat exchange tube of the heat exchanger are respectively connected to an inlet of a dishwasher and the rinsing water tank.

In Example 12, the subject matter of Example 11 optionally includes a circulating pump; and a steam recovery device auxiliary water tank; wherein the heat exchanger includes a heat exchange tube and the circulating pump is configured to circulate fluid through the steam recovery device auxiliary water tank and the heat exchange tube.

In Example 13, the subject matter of Example 12 optionally includes a one-way valve in communication with the circulating pump.

In Example 14, the subject matter of any one or more of Examples 11-13 optionally include a steam-water separator configured to receive fluid from the heat exchanger, the steam-water separator in communication with the dishwasher washing chamber.

Example 15 is a heat recovery system for a dishwasher, the heat recovery system comprising: a main wash tank; a waste water tank in communication with the main wash tank using a overflow channel, the waste water tank configured to receive heated water from the main wash tank; a rinse water tank at least partially surrounding the waste water tank, wherein the waste water tank is configured to transfer heat to the rinse water tank using a heat transfer wall separating the waste water tank from the rinse water tank; and wherein a water level in the waste water tank is less than a water level in the main wash tank to permit flow from the main wash tank to the waste water tank using the overflow channel.

In Example 16, the subject matter of Example 15 optionally includes a drain in communication with the waste water tank, the drain configured to receive water through a tortuous path from the waste water tank.

In Example 17, the subject matter of any one or more of Examples 15-16 optionally include wherein each of the main wash tank, the waste water tank, and a drain of the waste water tank are accessible by a user for cleaning.

In Example 18, the subject matter of any one or more of Examples 15-17 optionally include a pump configured to drive flow of fluid within the rinse water tank.

In Example 19, the subject matter of Example 18 optionally includes a packing material received in the rinse water tank, the packing material configured to turbulated fluid in the rinse water tank.

In Example 20, the subject matter of any one or more of Examples 15-19 optionally include wherein: the heat transfer wall comprises an upper heat transfer wall and a lower heat transfer wall; and the upper heat transfer wall extends laterally within the heat recovery system and the lower heat transfer wall extends vertically within the heat recovery system.

What is claimed is:

1. A high-temperature dishwasher heating system, comprising:
a high-temperature flushing water tank;
a main washing water tank;
a high-temperature flushing water tank heater received in the high temperature flushing water tank and configured to heat the high-temperature flushing water tank;
a thermal insulation chamber configured to transfer heat to the main washing water tank; and
a water tank partition plate separating water in the high-temperature flushing water tank from water in the main washing water tank, the water tank partition plate configured to transfer heat between the high-temperature flushing water tank and the main washing water tank.

2. The high-temperature dishwasher heating system of claim 1, further comprising:
a water inlet control valve in communication with an upper portion of the thermal insulation chamber
a thermal insulation chamber water discharge control valve in communication with a lower portion of the thermal insulation chamber;
wherein the water inlet control valve is configured to introduce water into the thermal insulation chamber and correspondingly increase a heat transfer coefficient of the insulation chamber; and
wherein the discharge control valve is configured to discharge water from the thermal insulation chamber and correspondingly reduce the heat transfer coefficient of the insulation chamber.

3. The high-temperature dishwasher heating system of claim 1, further comprising:
a high-temperature flushing water tank inlet control valve;
a high-temperature flushing water tank inlet;
a high temperature flushing water tank outlet;
a flushing water pump 112 configured to pump high-temperature water for the high-temperature flushing water tank;
a flushing water tank water supply tank having a water level higher than the flushing water pump;
wherein the high temperature flushing water tank outlet is arranged above at least one of the high temperature flushing water tank, the high temperature flushing water tank outlet, or the inlet of the flushing water pump;
wherein an inlet of the high-temperature flushing water tank inlet control valve is in communication with the flushing water tank water supply tank; and
wherein an outlet of the high-temperature flushing water tank inlet control valve is in communication with the high-temperature flushing water tank inlet.

4. The high-temperature dishwasher heating system of claim 3, further comprising:
a high-temperature flushing water tank inlet extension configured to supply low-temperature makeup water from the flushing water tank water supply tank to the high-temperature flushing water tank through the high-temperature flushing water tank inlet.

5. A waste water heat recovery device for a dishwasher, the waste water heat recovery device comprising:
a main washing water tank;
a waste water tank;
a main washing water tank overflow channel, wherein water in the main washing water tank can overflow into the waste water tank through the main washing water tank overflow channel in correspondence with a water level in the main washing water tank being higher than a set washing overflow position;
a waste water tank overflow channel, wherein water in the waste water tank can overflow to outside of the dishwasher through the waste water tank overflow channel in correspondence with a water level in the waste water tank being higher than a set waste overflow position;
a recovery water tank at least partially surrounding the waste water tank;
a water tank partition plate separating water in the recovery water tank from water in the waste water tank, the water tank partition plate configured to transfer heat between the recovery water tank and the waste water tank; and
a rinsing water tank configured to receive water from the recovery water tank.

6. The waste water heat recovery device of claim 5, further comprising:
a removable waste water tank overflow rod comprising the waste water tank overflow channel, wherein removal of the waste water tank overflow rod is configured to drain water from the waste water tank.

7. The waste water heat recovery device of claim 5, further comprising:
a rinsing water pump between the rinsing water tank and the recovery water tank;
a recovery water tank water level automatic control valve; and
wherein the recovery water tank water level automatic control valve is configured to control a liquid level of the recovery water tank to be higher than the level in rinsing water tank.

8. The waste water heat recovery device of claim 7, further comprising a recovery water tank overflow line configured to receive water overflowing from the recovery water tank in correspondence with the level in the recovery water tank exceeding an overflow position.

9. The waste water heat recovery device of claim 7, wherein:
an upper portion of the main washing water tank comprises the main washing water tank overflow channel; and
the recovery device includes a waste water tank cover configured for selective removal by a user; and
wherein removal of the waste water tank cover provides access to the main washing water tank overflow channel.

10. The waste water heat recovery device of claim 5, further comprising a waste water tank cover configured for selective removal and to inhibit flow of water into the waste water tank.

11. A dishwasher steam recovery device, comprising:
a fan;
a heat exchanger;
a chamber having a fan and a heat exchanger;
a rinsing water tank;
a dishwasher washing chamber;
a duct in communication with one or more of the dishwasher washing chamber, the fan, or the heat exchanger;
wherein the fan is configured to drive fluid in the duct from the dishwasher washing chamber to the heat exchanger; and
wherein an inlet and an outlet of a heat exchange tube of the heat exchanger are respectively connected to an inlet of a dishwasher and the rinsing water tank.

12. The dishwasher steam recovery device according to claim 11, further comprising:
a circulating pump; and
a steam recovery device auxiliary water tank;
wherein the heat exchanger includes a heat exchange tube and the circulating pump is configured to circulate fluid through the steam recovery device auxiliary water tank and the heat exchange tube.

13. The dishwasher steam recovery device according to claim 12, further comprising a one-way valve in communication with the circulating pump.

14. The dishwasher steam recovery device according to claim 11, further comprising:
a steam-water separator configured to receive fluid from the heat exchanger, the steam-water separator in communication with the dishwasher washing chamber.

15. A heat recovery system for a dishwasher, the heat recovery system comprising:
a main wash tank;
a waste water tank in communication with the main wash tank using a overflow channel, the waste water tank configured to receive heated water from the main wash tank;
a rinse water tank at least partially surrounding the waste water tank, wherein the waste water tank is configured to transfer heat to the rinse water tank using a heat transfer wall separating the waste water tank from the rinse water tank; and
wherein a water level in the waste water tank is less than a water level in the main wash tank to permit flow from the main wash tank to the waste water tank using the overflow channel.

16. The heat recovery system of claim 15, further comprising a drain in communication with the waste water tank, the drain configured to receive water through a tortuous path from the waste water tank.

17. The heat recovery system of claim 15, wherein each of the main wash tank, the waste water tank, and a drain of the waste water tank are accessible by a user for cleaning.

18. The heat recovery system of claim 15, further comprising a pump configured to drive flow of fluid within the rinse water tank.

19. The heat recovery system of claim 18, further comprising a packing material received in the rinse water tank, the packing material configured to turbulated fluid in the rinse water tank.

20. The heat recovery system of claim 15, wherein:
the heat transfer wall comprises an upper heat transfer wall and a lower heat transfer wall; and
the upper heat transfer wall extends laterally within the heat recovery system and the lower heat transfer wall extends vertically within the heat recovery system.
